(19) United States
(12) Patent Application Publication
(10) Pub. No.: US 2024/0007219 A1
(43) Pub. Date: Jan. 4, 2024

(54) CONDITIONAL BLIND DECODING LIMIT REDUCTION

(71) Applicant: QUALCOMM Incorporated, San Diego, CA (US)

(72) Inventors: Yuwei REN, Beijing (CN); Huilin XU, Temecula, CA (US); Iyab Issam SAKHNINI, San Diego, CA (US)

(21) Appl. No.: 18/038,973

(22) PCT Filed: Jan. 14, 2021
(86) PCT No.: PCT/CN2021/071740

§ 371 Date: May 25, 2023

(51) Int. Cl. H04L 1/00

(52) U.S. Cl. CPC H04L 1/0038

(57) ABSTRACT

Apparatus, methods, and computer program products for conditional blind decoding limit reduction for wireless communications are provided. An example apparatus may determine a PDCCH blind decoding limit based on a blind decoding limit reduction condition. The example apparatus may perform blind decoding for a PDCCH using one or more PDCCH candidates of a set of PDCCH candidates based on the determined PDCCH blind decoding limit.

### CROSS-REFERENCE TO RELATED APPLICATION

This application is a National Stage Application filed under 35 U.S.C § 371 of PCT International Application Serial No. PCT/CN2021/071740 entitled “CONDITIONAL BLIND DECODING LIMIT REDUCTION” and filed on Jan. 14, 2021, which is expressly incorporated by reference herein in its entirety.

### BACKGROUND

### Technical Field

The present disclosure relates generally to communication systems, and more particularly, to communication systems with physical downlink control channel (PDCCH) blind decoding.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The UE determines a PDCCH blind decoding limit based on a blind decoding limit reduction condition. The UE performs blind decoding for a physical downlink control channel (PDCCH) using one or more PDCCH candidates of a set of PDCCH candidates based on the determined PDCCH blind decoding limit.

In another aspect of the disclosure, a method, a computer-readable medium, and an apparatus at a base station are provided. The base station configures a UE with a blind decoding limit reduction condition associated with a PDCCH blind decoding limit. The base station transmits PDCCH to the UE based on a configuration for the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates an example PDCCH receiving process.

FIG. 5 illustrates example communications between a UE and a base station.

FIG. 6 illustrates example slots with conditional blind decoding limit reduction.

FIG. 7 illustrates example slots with conditional blind decoding limit reduction.

FIG. 8 is a flowchart of a method of wireless communication.

FIG. 9 is a flowchart of a method of wireless communication.

FIG. 10 is a diagram illustrating an example of a hardware implementation for an example apparatus.

FIG. 11 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

A user equipment (UE) may receive a physical downlink control channel (PDCCH) from a base station. In the PDCCH receiving process, the UE may not know the number of control resource sets (CCEs) occupied by the current PDCCH to be received, the DCI format of the PDCCH, or where the location of the PDCCH information. However, the UE may be aware of the information that the UE expects to receive in the PDCCH (e.g., paging/system information, a random access channel (RACH) response, grant, etc.) and may be aware of the radio network temporary identifier (RNTI) for the PDCCH. The UE may perform PDCCH blind decoding based on such expected information and the RNTI. For example, for different expected information, the UE may use the corresponding RNTI to perform cyclic redundancy (CRC) check on the received transport block (TB) that has the CRC scrambled with the respective RNTI. If the CRC check is successful, then the UE knows that this information is what it needs and may accordingly derive the content of the DCI message. If UE fails to decode the PDCCH, it may keep attempting to decode the PDCCH using a different set of PDCCH candidates in the upcoming PDCCH monitoring occasion.

Blind decoding may consume resources, such as computing power, energy (e.g., energy stored in a battery), or other resources of a UE. Therefore, the UE may be configured with a blind decoding limit on the number of blind decoding (BD) per slot. For certain UEs, such as reduced capability UEs, reducing the blind decoding limit may be beneficial. Aspects herein provide dynamic, conditional blind decoding limit reduction mechanisms.

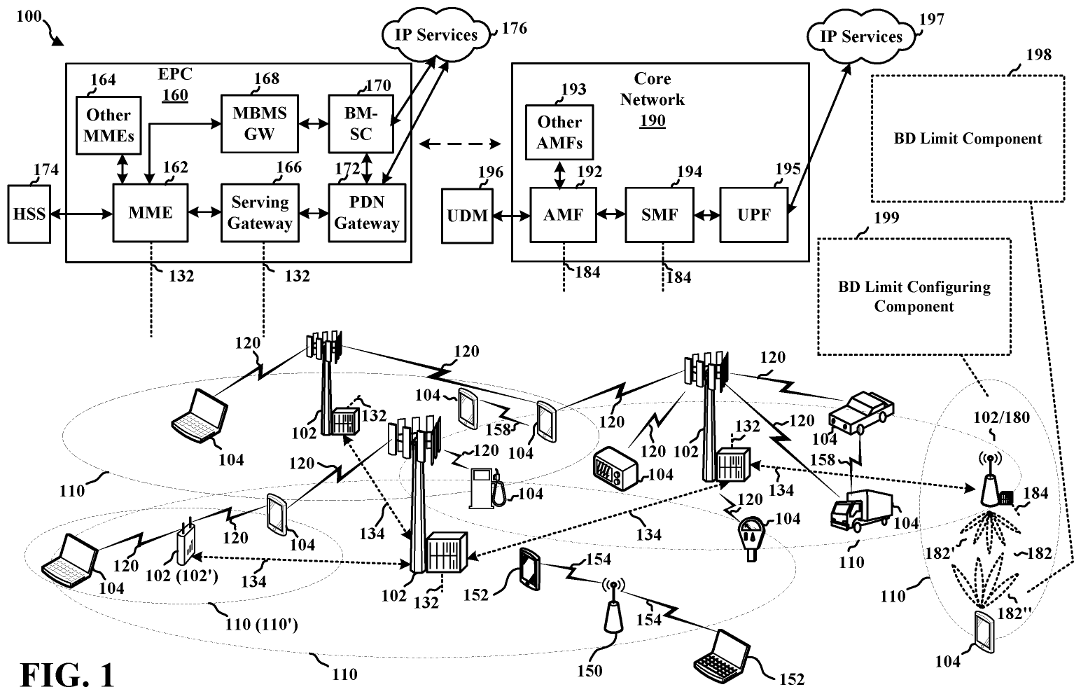

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from abase station 102 to a UE 104. The communication links 120 may use multiple-input and multiple-output (IMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN)Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include a BD limit component 198. In some aspects, the BD limit component 198 may be configured to determine a PDCCH blind decoding limit based on a blind decoding limit reduction condition. The BD limit component 198 may be further configured to perform blind decoding for a PDCCH using one or more PDCCH candidates of a set of PDCCH candidates based on the determined PDCCH blind decoding limit. In some aspects, the base station 180 may include a BD limit configuring component 199. In some aspects, the BD limit configuring component 199 may be configured to configuring a UE with a blind decoding limit reduction condition associated with a PDCCH blind decoding limit. The BD limit configuring component 199 may be further configured to transmit PDCCH to the UE based on a configuration for the UE.

Although the following description may be focused on 5G NR, the concepts described herein may be applicable to other similar areas, such as LTE, LTE-A, CDMA, GSM, and other wireless technologies.

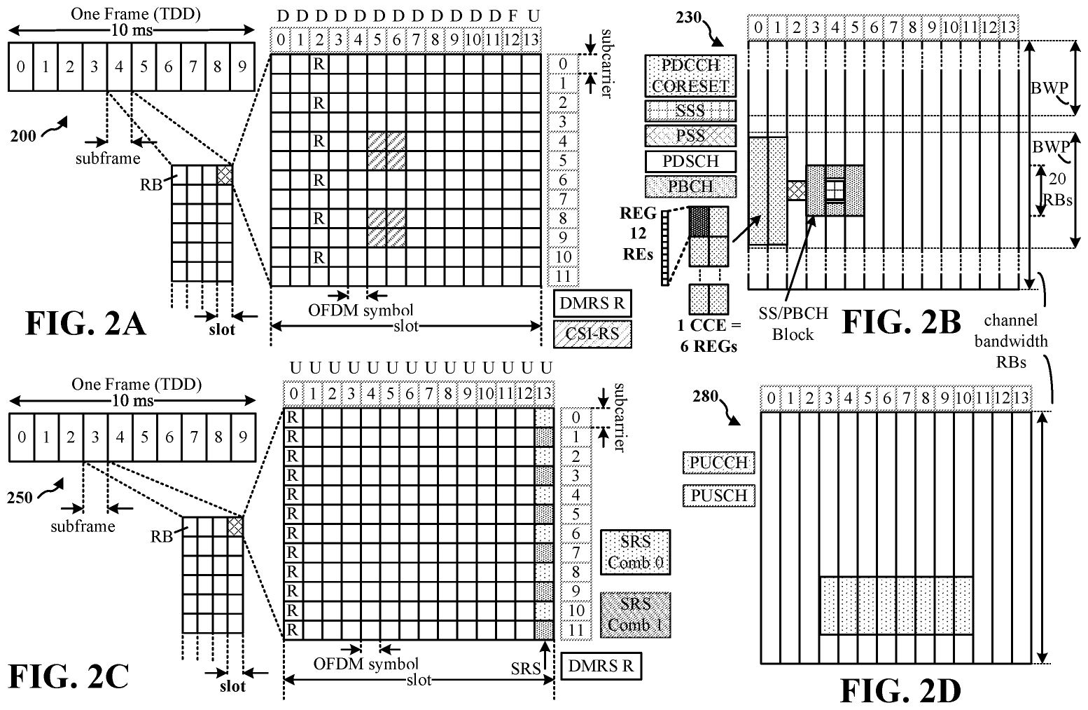

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP)orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 29 slots/subframe. The subcarrier spacing and symbol length/duration are a function of the numerology. The subcarrier spacing may be equal to 2^{μ} * 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PI), a rank indicator (RI), and hybrid automatic repeat request (HARQ) acknowledgment (ACK) (HARQ-ACK) information (ACK/negative ACK (NACK)) feedback. The PUSCH carries data, and may additionally be used to carry a buffer status report (BSR), a power headroom report (PHR), and/or UCI.

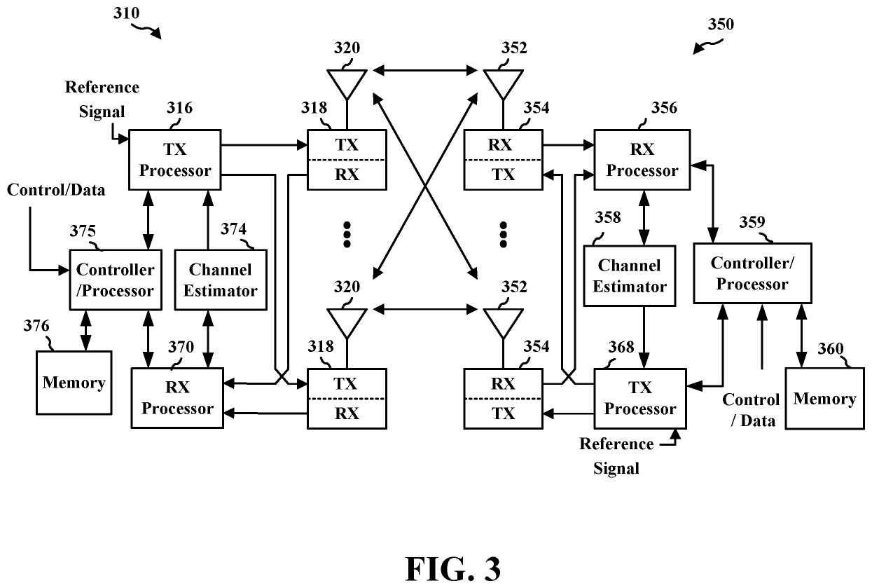

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with BD limit component 198 of FIG. 1.

At least one of the TX processor 316, the RX processor 370, and the controller/processor 375 may be configured to perform aspects in connection with BD limit configuring component 199 of FIG. 1.

A user equipment (UE) may monitor time and frequency resources in order to receive a physical downlink control channel (PDCCH) from abase station. A control resource set (CORESET) corresponds to a set of physical resources in time and frequency that a UE uses to monitor for PDCCH/DCI. Each CORESET comprises one or more resource blocks in the frequency domain and one or more symbols in the time domain. As an example, a CORESET might comprise multiple RBs in the frequency domain and 1, 2, or 3 contiguous symbols in the time domain. A Resource Element (RE) is a unit indicating one subcarrier in frequency over a single symbol in time. A Control Channel Element (CCE) includes Resource Element Groups (REGs), e.g., 6 REGs, in which an REG may correspond to one RB (e.g., 12 REs) during one OFDM symbol. REGs within a CORESET may be numbered in increasing order in a time-first manner, starting with 0 for the first OFDM symbol and the lowest-numbered resource block in the control resource set. A UE can be configured with multiple CORESETs, each CORESET being associated with a CCE-to-REG mapping. A search space may comprise a set of CCEs, e.g., at different aggregation levels. For example, the search space may indicate a number of candidates to be decoded, e.g., in which the UE performs decoding. A CORESET may comprise multiple search space sets. A base station may configure multiple CORESETs and multiple search space sets for a UE. For example, the base station may configure three CORESETs and 10 search space sets per BWP for the UE. The UE may be configured for multiple BWPs, e.g., four BWPs. Each CORESET ID of the CORESETS configured for the UE may map to a particular BWP, and each search space set ID of the multiple search space sets configured for the UE may map to a particular BWP, for example.

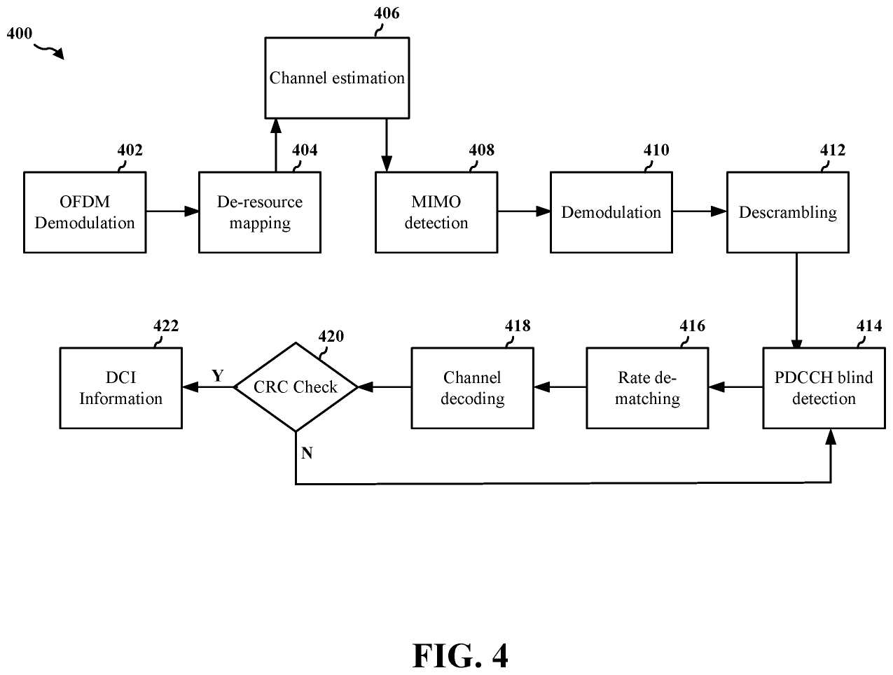

FIG. 4 illustrates an example PDCCH receiving process performed by a UE. Upon receiving a signal from the base station, the UE may perform OFDM demodulation 402. After performing the OFDM demodulation 402, the UE may perform de-resource mapping 404. After performing the de-resource mapping 404, the UE may perform channel estimation 406. After performing the channel estimation 406, the UE may perform MIMO detection 408. Then, the UE may demodulate the signal at demodulation 410 and may descramble the received signal at 412. In the PDCCH receiving process, the UE may not know the number of CCEs occupied by the current PDCCH to be received, the DCI format information, or where the location of the information. The UE may perform PDCCH blind detection 414, rate-dematching 416, and channel decoding 418. However, the UE may be aware of the information that the UE expects to receive in the PDCCH and may be aware of the RNTI. For example, in an idle state, the UE may expect to receive paging information or system information in PDCCH from the base station. After initiating a random access procedure, the UE may expect a RACH response in PDCCH from the base station. When there is uplink data buffered at the UE and waiting to be sent, the UE may expect to receive an uplink grant in PDCCH from the base station. The UE may perform PDCCH blind decoding based on such expected information and the RNTI. For example, for different expected information, the UE may use the corresponding RNTI to perform CRC check 420 on the received TB that has the CRC scrambled with the respective RNTI. If the CRC check is successful, then the UE knows that this information is what it needs and may accordingly derive the content of the DCI message and derive the DCI information 422. If UE fails to decode the PDCCH, it may keep attempting to decode the PDCCH by reattempting PDCCH blind detection using a different set of PDCCH candidates in the upcoming PDCCH monitoring occasion.

A PDCCH candidate is determined based on a CCE aggregation level. For some PDCCH formats, a single CCE may provide enough resources to for transmission of the DCI information. The CCE Aggregation level provides for one or more CCEs for a single PDCCH candidate. For example, an aggregation level of 2 or more provides for a PDCCH candidate that is based on a combination of multiple CCEs.

Blind decoding may consume UE resources, such as computing power, energy (e.g., energy stored in a battery), etc. Therefore, a UE may not attempt to decode every PDCCH candidate, or may limit blind decoding attempts for PDCCH candidates. To keep minimum restrictions on the scheduler and at the same time to maintain a lower number of blind decoding attempts by the UE, search spaces (SSs) may be configured for the UE. A SS set may be a common SS set (CSS) and UE-specific SS set (UESS). In some communication systems, UEs may decode the PDCCH using 5 UE-specific search space aggregation levels (1,2,4,8,16) and 3 common search space aggregation Levels (4 & 8 & 16) as illustrated in table 1 below:

TABLE 1

| Search | Aggregation | Num of the | Size |
|---|---|---|---|
| Space Type | Level | PDCCH candidates | (In CCEs) |
| UESS | 1 | 6 | 6 |
| | 2 | 6 | 12 |
| | 4 | 2 | 8 |
| | 8 | 2 | 16 |
| | 16 | 1 | 16 |
| CSS | 4 | 4 | 16 |
| | 8 | 2 | 16 |
| | 16 | 1 | 16 |

A common search space set may be associated with a DCI where the DCI CRC is scrambled with a system information-RNTI (SI-RNTI), random access-RNTI (RA-RNTI), temp cell-RNTI (TC-RNTI), paging-RNTI, interruption-RNTI, slot format indication-RNTI (SFI-RNTI), transmission power control-RNTI (TPC-RNTI), TPC-PUSCH-RNTI, TPC-SRS-RNTI, Cell-RNTI (C-RNTI), configured scheduling-RNTI (CS-RNTI), or the lie. A UE specific search space set may be associated with a DCI where the DCI CRC is scrambled with a C-RNTI or a CS-RNTI.

As part of a PDCCH blind decoding procedure (which may also be referred to as a “blind detecting” procedure), the LUE may UE receive the PDCCH configuration information in a range of physical resources based on a CORESET and SS set configuration received from a base station. In the range of physical resources, the UE may apply different PDCCH configuration parameters (aggregation level (AL), number of PDCCH candidates per AL and RNTI) to determine the possible locations and CCEs where a PDCCH may be transmitted (e.g., the possible locations may be referred to as PDCCH candidates). The UE may apply an RNTI based scrambling mask for each PDCCH candidate and attempt to obtain the PDCCH/DCI for the PDCCH candidate by blind detection.

In some systems, common search space (CSS) set RNTIs may use a particular set of aggregation levels, such as aggregation levels 4/8/16. In some examples, the aggregation levels for the CSS PDCCH based on a common RNTI may be defined. For CCE aggregation level 4 (AL4) there are 16 CCEs. The UE may perform channel estimation on the first PDCCH candidate that includes 4 CCEs, and then the UE may attempt to decode the PDCCH to see whether the expected RNTI matches with the RNTI scrambled with the DCI CRC. If the RNTIs do not match, the UE may perform channel estimation 406 on the second PDCCH candidate that includes the next 4 CCEs. Similar to the first PDCCH candidate, the UE may attempt to decode the PDCCH of the second candidate and may check for an RNTI match. The UE may continue to attempt to decode PDCCH candidates. Thus, there may be two more repetitions, e.g., up to a total of 4 blind decoding attempts for the four PDCCH candidates for AL4. If the expected RNTI does not match with any of the four PDCCH candidates for AL4, then the UE may consider (e.g., attempt to receive PDCCH in) the PDCCH candidates of CCE aggregation level 8 (AL8). For CCE AL8, channel estimation may be performed for the first PDCCH candidate that includes 8 CCEs. Then, the UE performs PDCCH decoding and checks for RNTI matching, e.g., as described in connection with AL4. If there is no RNTI match, then the UE may perform channel estimation and PDCCH decoding for the second PDCCH candidate that includes the next 8 CCEs. If the RNTI of PDCCH received in the second PDCCH candidate matches the DCI CRC scrambled RNTI, then UE may get to know that DCI is allocated for that UE and may derive the DCI information 422 to get the DL/UL scheduling information.

If the UE does not successfully receive PDCCH based on the PDCCH candidates for AL4 or AL8, the UE may proceed to attempt to decode PDCCH candidates based on AL16.

The UE may be configured with a blind decoding limit on the number of blind decoding per slot. For example, the UE PDCCH blind decoding limit may be define d for the UE to monitor PDCCH candidate(s) where the aggregation levels and number of decoding candidates per aggregation level are configurable. The blind decoding limit may be considered as a benchmark for the base station when configuring aggregation levels and/or the number of PDCCH candidates for each aggregation level. The value of the blind decoding limit may have an impact on the complexity (e.g., computing complexity) and power cost of the UE PDCCH decoding. An example limit of monitored PDCCH candidates for operation with a single cell is provided in table 2 below. Table 2 illustrates an example in which a maximum number of monitored PDCCH candidates (M_{PDCCH}^{max,slot,u}) per slot for a downlink BWP may be based on a subcarrier spacing (μ) configuration for a single serving cell.

TABLE 2

| | Maximum number of monitored PDCCH candidates |
|---|---|
| μ | per slot and per serving cell M_{PDCCH}^{max, slot, μ} |
| 0 | 44 |
| 1 | 36 |
| 2 | 22 |
| 3 | 20 |

In addition to higher capability devices wireless communication may support reduced capability devices. Among others, examples of higher capability devices include premium smartphones, V2X devices, URLLC devices, eMBB devices, etc. Among other examples, reduced capability devices may include wearables, industrial wireless sensor networks (IWSN), surveillance cameras, low-end smartphones, etc. For example, NR communication systems may support both higher capability devices and reduced capability devices. A reduced capability device may be referred to as an NR light device, a low-tier device, a lower tier device, etc. Reduced capability UEs may communicate based on various types of wireless communication. For example, smart wearables may transmit or receive communication based on low power wide area (LPWA)/mMTC, relaxed IoT devices may transmit or receive communication based on URLLC, sensors/cameras may transmit or receive communication based on eMBB, etc.

In some examples, a reduced capability UE may have reduced transmission bandwidth or reception bandwidth than other UEs. For instance, a reduced capability UE may have an operating bandwidth between 5 MHz and 20 MHz for both transmission and reception, in contrast to other UEs which may have a bandwidth of up to 100 MHz. As a further example, a reduced capability UE may have a reduced number of reception antennas in comparison to other UEs. For instance, a reduced capability UE may have only a single receive antenna and may experience a lower equivalent receive signal to noise ratio (SNR) in comparison to higher capability UEs that may have multiple antennas. Reduced capability UEs may also have reduced computational complexity than other UEs.

It may be helpful for communication to be scalable and deployable in a more efficient and cost-effective way. For example, it may be possible to relax or reduce peak throughput, latency, and/or reliability requirements for the reduced capability devices. In some examples, reductions in power consumption, complexity, production cost, and/or reductions in system overhead may be prioritized. As an example, industrial wireless sensors may have an acceptable up to approximately 100 ms. In some safety related applications, the latency of industrial wireless sensors may be acceptable up to 10 ms or up to 5 ms. The data rate may be lower and may include more uplink traffic than downlink traffic. As another example, video surveillance devices may have an acceptable latency up to approximately 500 ms.

For certain UEs, such as reduced capability UEs, reducing the blind decoding limit may improve efficient operation of the UE and/or help to reduce the complexity of the UE. A blind decoding limit, e.g., as described in connection with Table 2, and/or a CCE limit may help to reduce or limit processing at the UE to receive PDCCH. However, such limits may be applied by the UE in every slot. A CCE reduction/limitation may cause network scheduling limitations. A blind decoding limitation may be applied for each slot, e.g., in all slots, or for a number of slots (e.g., based on a DCI indication). However, such limitations do not address different types of PDCCH configurations that schedule different downlink data information in different slots. The blind decoding limit reduction is a baseband operation, and aspects presented herein enable the reduction in blind decoding (e.g., a particular blind decoding limit) to be applied in a more dynamic manner. For example, the UE may apply different blind decoding limits in a more dynamic manner, e.g., without applying the same blind decoding limit in consecutive slots for at least the indicated number of slots. Aspects presented herein enable the UE to apply a conditional blind decoding limit that varies based on different conditions in different slots.

In some aspects, the UE may benefit from reduced processing of less than 44, 36, 22, or 20 PDCCH candidates by reducing the blind decoding limit per slot. Aspects herein provide dynamic, conditional blind decoding limit reduction mechanisms. The aspects presented herein provide improved scheduling flexibility while reducing the PDCCH decoding complexity.

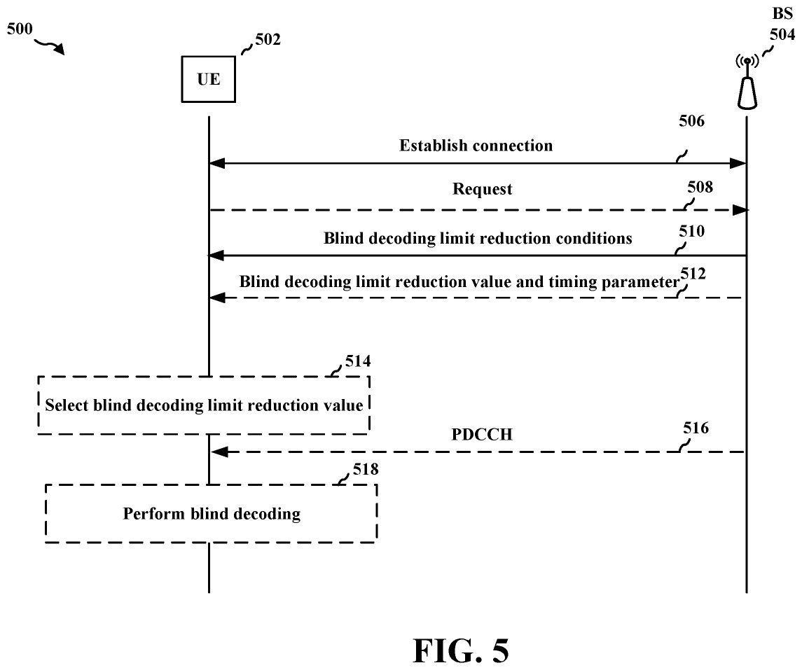

FIG. 5 illustrates an example communication flow 500 between a UE 502 and a base station 504 including the application of a condition blind decoding limit. As illustrate d in FIG. 5, the UE 502 and the base station 504 may establish a connection at 506. The base station 504 may configure the UE 502 (such as via radio resource control (RRC) signaling or DCI indication in a prior slot) with conditional BD limit reduction rules including blind decoding limit reduction conditions 510 and blind decoding limit reduction value and timing parameter 512. In some aspects, the blind decoding limit reduction conditions 510 may define that a conditional BD limit reduction may be triggered by the UE if a particular condition is present (e.g., detected by the UE).

For example, the blind decoding limit reduction conditions 510 may include that if a type of DCI with a reduced PDCCH overhead is configured for the UE, such as multi-TB scheduling DCI in the slot, the UE may apply a corresponding blind decoding limit to attempt to receive PDCCH. For example, if the UE is configured with multi-TB scheduling in the slot, the UE may attempt to receive the corresponding DCI based on a configured BD limit reduction. In some aspects, a multi-TB scheduling DCI may include information in a plurality of fields that may be decodable to obtain DCI for a plurality of TBs. For example, the decodable information in such a multi-TB scheduling DCI may be jointly decoded according to an encoding scheme where each possible output of the encoding scheme corresponds to a jointly valid combination of at least two fields.

In some aspects, the blind decoding limit reduction conditions 510 may include a condition in which a slot has configured periodic UL/DL resources, e.g., semi-persistent scheduling SPS resources or configured grant (CG) resources. For example, when UE is configured with SPS, or works in one specific cell group in the case of CG, e.g., in a secondary cell group (SCG), the UE may apply a corresponding blind decoding limit reduction based on a configured value. Such a blind decoding limit may not have a negative performance impact because the UE may already know the pre-configured slot format or other information, e.g., periodic UL/DL resources.

In some aspects, the blind decoding limit reduction conditions 510 may include a condition in which UE specific DCI is configured in a slot, e.g., and not common DCI. For example, when the UE specific DCI is configured, which is usually a lower-priority DCI, UE may perform blind detection for fewer PDCCH candidates with the BD limit reduction. The BD limit reduction may help to reduce the complexity of the processing by the UE. In some aspects, the condition may be based on a priority of the DCI configured/scheduled in a slot. For example, the UE may apply a first BD limit reduction for a first priority level DCI configured in a first slot and may apply a second BD limit reduction for a second priority DCI configured in a second slot. The UE may apply a lower BD limit if a lower priority DCI (e.g., and not a higher priority DCI) is configured in a slot and may apply a higher BD limit if a higher priority DCI is configured in the slot.

In some aspects, the blind decoding limit reduction conditions 510 may include a condition based on DCI format type, e.g., the DCI format type of DCI scheduled in the corresponding slot. If that a particular DCI format type a is configured, such as fallback DCI, DCI 0-0, DCI 1-0, or the like, the UE may apply a corresponding BD limit reduction.

In some aspects, the blind decoding limit reduction conditions 510 may be based on decoupling of UL and DL non-fallback configuration in a SS set. Thus, if UL and DL non-fallback configurations in an SS set are decoupled, the UE may apply a first BD limit reduction, and if the UL and DL non-fallback configurations in an SS set are coupled, the UE may apply a second BD limit reduction.

In some aspects, additional conditions or a combination of the conditions (i.e., the combination may need to be present/detected by the UE) may be applied by the UE to determine BD limit reduction. If the blind decoding limit reduction conditions 510 are met, the blind decoding limit reduction may be triggered based on the blind decoding limit reduction value and timing parameter 512. In some aspects, the UE 502 may select (514) one blind decoding limit reduction value from a set of blind decoding limit reduction values configured by the base station 504 based on the corresponding condition triggered. In some aspects, the UE 502 may select one blind decoding limit reduction value from a set of blind decoding limit reduction values configured by the base station 504 based on a configuration. The UE 502 may perform blind decoding 518 based on the reduced blind decoding limit.

In some examples, the base station may configure the value of the reduced BD limit and/or a timeline for application of the reduced BD limit, e.g., at 512, when a particular condition is met. In some examples, the base station may transmit DCI to provide a timeline indication and/or a particular BD limit to the UE.

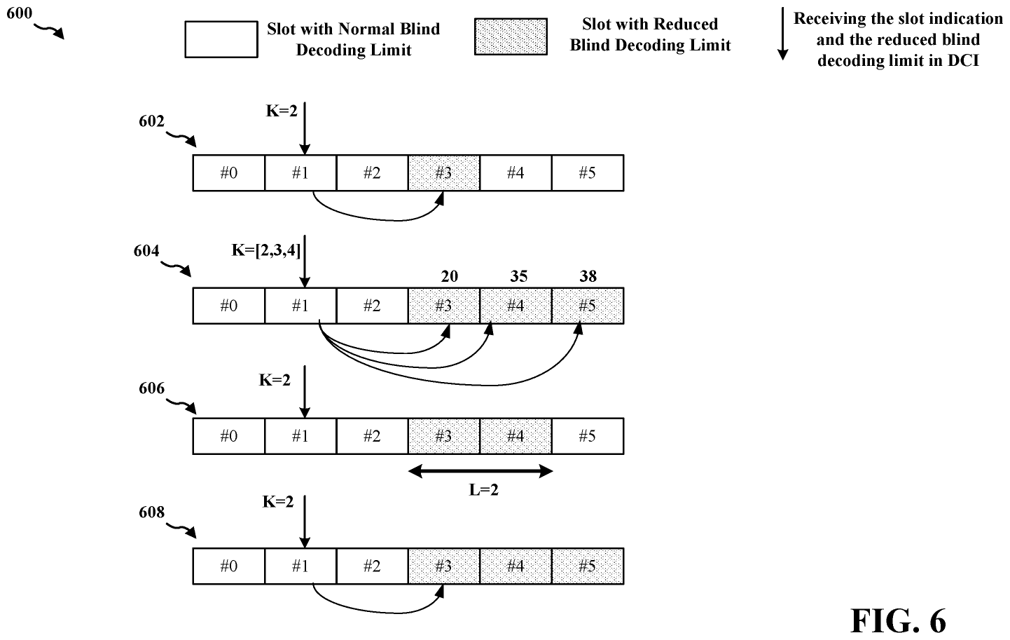

FIG. 6 illustrates exampled 600 of e slots with conditional blind decoding limit reduction. In some aspects, the base station 504 uses a DCI (that may or may not be associated with the PDCCH 516 to be decoded and may meet the blind decoding limit reduction conditions 510) to indicate the blind decoding limit reduction value and/or timing parameter 512. The timing parameter k may be the delay in slots between the UE detecting an occurrence of the blind decoding limit reduction condition (e.g., based on the DCI) and the slots in which the UE is to apply the corresponding BD limit reduction based on the condition having been met for the DCI received in slot #1. For example, as illustrated in example 602, if the UE 502 decodes the DCI information in slot #1, and gets the timing parameter k, the UE may apply a reduced blind decoding limit (equal to the blind decoding limit reduction value) is after k=2 slots following the occurrence of the corresponding condition in slot #1. Thus, the UE may apply the reduced blind decoding limit at slot #3, e.g., k=2 after slot #1.

In some aspects, the timing parameter k may include several values indicating for the to apply the reduced blind decoding limits in multiple slots following the occurrence of the condition. In some examples, the occurrence of the condition may be based on the DCI that indicates the timing parameters. As illustrated in example 604, the timing parameter k indicates multiple slots parameters, e.g., 2, 3, and 4, which means that the reduced blind decoding limits may be effective at slots #3, #4, and #5, e.g., at a spacing of 2, 3, and 4 from slot #1 in which the DCI is received.

In some aspects, the timing parameter k may include one starting index and a continuous length following the starting index and during which the BD limit reduction is to be applied by the UE following an occurrence of a condition. For example, as illustrated in example 604, the starting index may be slot #3 and the continuous length may be 2, which means that the reduced blind decoding limits may be effective at slots #3 and #4 based on an occurrence of the corresponding condition.

In some aspects, the timing parameter k may include a minimum value, e.g., a minimum delay between an occurrence of a condition and application of the BD limit reduction. For example, as illustrated in example 606, the timing parameter k may include a minimum value 2 which means that the reduced blind decoding limits may be effective after slot #3 based on an occurrence of the corresponding condition.

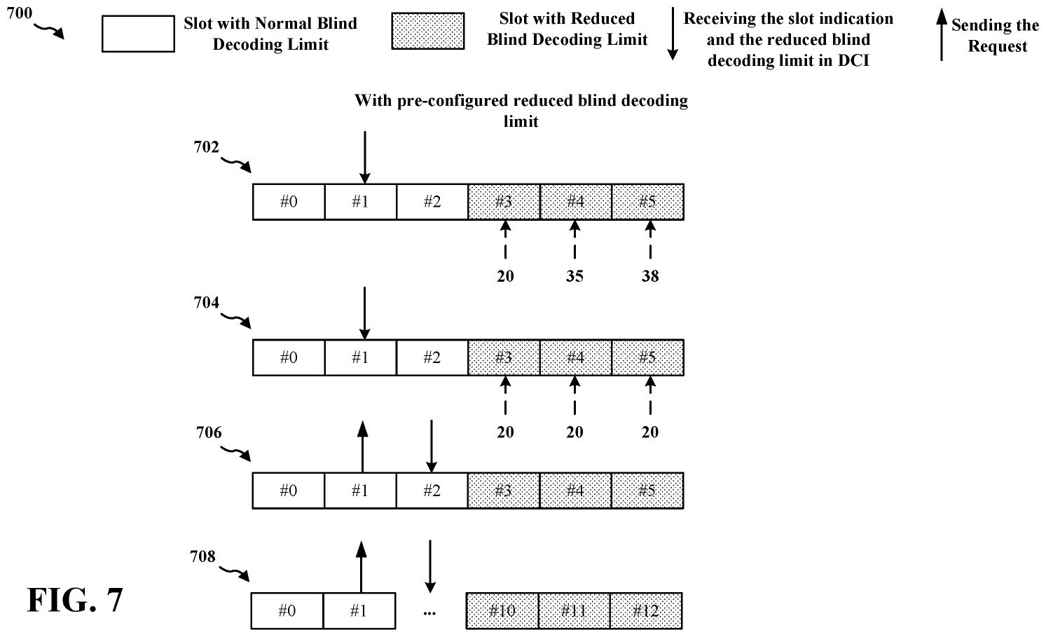

FIG. 7 illustrates examples 700 slots with conditional blind decoding limit reduction. In some aspects, the DCI may include at least the blind decoding limit reduction values, e.g., a particular BD limit to be applied for a corresponding condition, for the indicated slots. In some aspects, the base station may indicate different blind decoding limit reduction values for different slots. For example, as illustrated in example 702, the blind decoding limit reduction value may include 20, 35, and 38 for slots #3, #4, and #5. In some aspects, the base station may indicate a same blind decoding limit reduction value for different slots. For example, as illustrated in example 704, the blind decoding limit reduction value may include 20 for slots #3, #4, and #5.

In some aspects, the blind decoding limit reduction conditions 510 and the blind decoding limit reduction value and timing parameter 512 may be transmitted by the base station 504 in response to a request 508 from the UE 502. The UE 502 may request one or more reduced blind decoding limits in the UE assistance information to network. In some examples, the UE may request a set of reduced BD limits. The UE may transmit an UL request for the BD limit reduction based on (e.g., transmitted via) PUSCH/PUCCH/physical random access channel (PRACH)PRACH. The base station 504 may accordingly configure one or more of the blind decoding limit reduction value and timing parameter 512 in response to the request 508 from the UE 502. In some aspects, the UE 502 may transmit the request 508 when the UE 502 establishes a connection, e.g., accessing one base station, occupying one band, or switching to one mode, or the like.

In some aspects, the blind decoding limit reduction value(s) may be based on the UE 502's capability. For example, the UE may have a capability for (e.g., require or request) a reduced BD limit when the UE establishes a connection. The UE may have a capability for a reduced BD limit when the UE accesses a single base station. The UE may have a capability for a reduced BD limit when the UE occupies a single band. The UE may have a capability for a reduced BD limit when the UE switches to a particular mode. In some examples, the blind decoding limit reduction may be based on one or more defined conditions. As an example, a defined condition may indicate for the UE to apply a particular BD limit reduction when the UE establishes a connection, when the UE accesses a single base station, when the UE occupies a single band, and/or when the UE switches to a particular mode. For example, the UE 502 may access the (new) base station 504, which is configured with a fixed slot format configuration. The UE 502 may decode the DCI with less PDCCH candidates, thereby saving power, by being configured with the BD limit reduction. When the UE 502 has a low battery, the base station 504 may configure the reduced blind decoding limits to save the UE 502's power.

In some aspects, the UE 502 requests one value or a set of the reduced blind decoding limits for a set of slots. The set of slots may be one slot, more than on continuous slots, or one or more slots in one range. The network configuration could be common for the set of slots or may be independent for different slots in the set of slots. For example, as illustrated in example 706 in FIG. 7, at slot #1, the UE 502 sends the request for the reduced blind decoding limit for the slots #3, #4, and #5. In some aspects, the UE 502 may request one value for one condition. For example, if the UE 502 is UE is configured with SPS, e.g., with fixed UL/DL slot format, the UE 502 may request the reduced BD limit for the fixed UL/DL slots. For example, as illustrated in example 708 in FIG. 7, the UE 502 may request at slot #1 and the reduced blind decoding limit may be applicable for slots #10, #11, and #12.

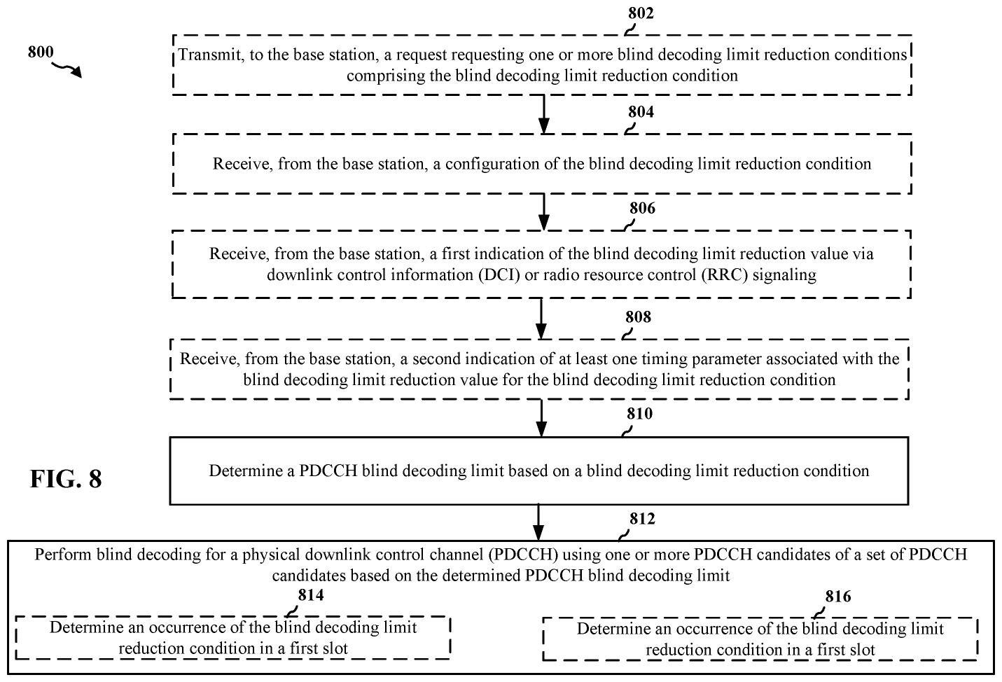

FIG. 8 is a flowchart 800 of a method of wireless communication. The method may be performed by a UE (e.g., the UE 104, the UE 502, the UE described in connection with FIGS. 6 and 7; the apparatus 1002). The method may enable the UE to perform blind decoding based on a conditional blind decoding limit reduction.

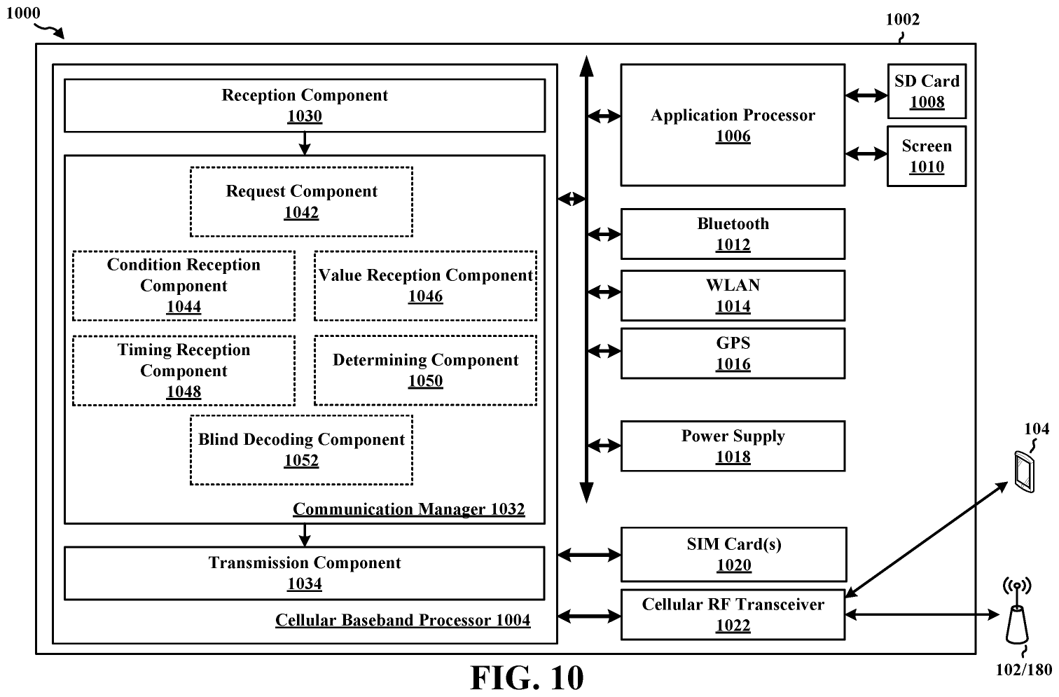

At 802, the UE transmits, to the base station, a request requesting one or more blind decoding limit reduction conditions comprising a blind decoding limit reduction condition. 508 in FIG. 5 illustrates an example of a UE 502 requesting one or more blind decoding limit reduction conditions. In some aspects, 802 may be performed by request component 1042 in FIG. 10. In some aspects, the UE transmits the request to the base station in UE assistance information such as UE assistance information via RRC signaling. In some aspects, the request for the blind decoding limit reduction condition is transmitted via a PUSCH, PUCCH, or PRACH. In some aspects, the UE transmits the request when the UE establishes a connection with the base station. In some aspects, the request is for a set of blind decoding limit reduction conditions associated with one of: one slot, more than one slots, or one or more conditions.

At 804, the UE receives, from the base station, a configuration of the blind decoding limit reduction condition. In some aspects, the UE receives, from the base station, the blind decoding limit reduction condition in response to the request. 510 in FIG. 5 illustrates an example of the UE 502 receiving a configuration of the blind decoding limit reduction condition from the base station 504. In some aspects, 804 may be performed by condition reception component 1044 in FIG. 10. In some aspects, the blind decoding limit reduction condition is associated with a slot. For example, 602 in FIG. 6 illustrates an example where the blind decoding limit reduction condition is associated with a slot. In some aspects, the blind decoding limit reduction condition is associated with multiple slots. For example, 604 in FIG. 6 illustrates an example where the blind decoding limit reduction condition is associated with multiple slots. In some aspects, the blind decoding limit reduction condition is based on a type of DCI. For example, the blind decoding limit reduction condition may be based on DCI with a reduced PDCCH overhead such as a multi-TB scheduling DCI that may include information in a plurality of fields that may be decodable to obtain DCI for a plurality of TBs. For example, the decodable information in such a multi-TB scheduling DCI may be jointly decoded according to an encoding scheme where each possible output of the encoding scheme corresponds to a jointly valid combination of at least two fields. In some aspects, the blind decoding limit reduction condition is based on the slot being associated with SPS or a CG. In some aspects, the blind decoding limit reduction condition is based on the slot being configured with UE specific DCI. In some aspects, the blind decoding limit reduction condition is based on a DCI format type (e.g., one or more of DCI x_y or the like, x and y being numbers). In some aspects, the blind decoding limit reduction condition is based on a decoupling of an uplink and downlink non-fallback configuration in a SS set associated with the slot. In some aspects, the UE receives the configuration of one or more blind decoding limit reduction conditions in RRC signaling.

At 806, the UE receives, from the base station, a first indication of a blind decoding limit reduction value via DCI or RRC signaling. 512 in FIG. 5 illustrates an example of the UE 502 receiving, from the base station 504, the blind decoding limit reduction value. In some aspects, 806 may be performed by value reception component 1046 in FIG. 10.

At 808, the UE receives, from the base station, a second indication of at least one timing parameter associated with the blind decoding limit reduction value for the blind decoding limit reduction condition. 512 in FIG. 5 illustrates an example of a UE 502 receiving the timing parameter from the base station 504. In some aspects, 808 may be performed by timing reception component 1048 in FIG. 10. In some aspects, the at least one timing parameter includes a delay between the slot and one or more slots in which the blind decoding is performed based on the PDCCH blind decoding limit. For example, the timing parameter may be k which indicates the delay between slot #1 and slot #3 in examples 602/604/606/608 in FIG. 6. In some aspects, the at least one timing parameter comprises an indicated number of slots. For example, the timing parameter may indicate 2 slots as illustrated in example 602 in FIG. 6. In some aspects, the at least one timing parameter comprises a multi-value indication indicating multiple numbers of slots. For example, the timing parameter may indicate 2, 3, and 4 slots as illustrated in example 604 in FIG. 6. In some aspects, the at least one timing parameter comprises a starting index and a continuous length. For example, the timing parameter may indicate starting index 2 and a continuous length of 2 as illustrated in example 606 in FIG. 6. In some aspects, the at least one timing parameter comprises a minimum value. For example, the timing parameter may indicate a minimum value of 2 as illustrated in example 608 in FIG. 6.

At 810, the UE determines the PDCCH blind decoding limit based on the blind decoding limit reduction condition. In some aspects, 810 may be performed by determining component 1050 in FIG. 10. In some aspects, the UE determines the PDCCH blind decoding limit to be a blind decoding limit reduction value based on an occurrence of the blind decoding limit reduction condition. For example, the blind decoding limit reduction condition is considered as satisfied and the UE may apply the blind decoding limit reduction based on the value/timing parameter if a defined type of DCI is detected. In some aspects, the blind decoding limit reduction value is applicable to one slot in the one or more slots in which the blind decoding is performed based on the PDCCH blind decoding limit. For example, as illustrated in example 702 of FIG. 7, the value 20 may be applicable to one slot (slot #3). In some aspects, the blind decoding limit reduction value is applicable to multiple slots in the one or more slots in which the blind decoding is performed based on the PDCCH blind decoding limit. For example, as illustrated in example 704 of FIG. 7, the value 20 may be applicable to three slots (slot #3, #4, and #5).

At 812, the UE performs blind decoding for a PDCCH using one or more PDCCH candidates of a set of PDCCH candidates based on the determined PDCCH blind decoding limit. In some aspects, 812 may be performed by blind decoding component 1052 in FIG. 10. FIGS. 6 and 7 illustrate examples of a UE performing blind decoding based on a blind decoding limit. In some aspects, as part of 812, at 814, the UE determines an occurrence of the blind decoding limit reduction condition in a first slot. In some aspects, the UE determines the PDCCH blind decoding limit based on the occurrence of the blind decoding limit reduction condition. For example, 604 in FIG. 6 illustrates an example where the UE determines a first PDCCH blind decoding limit (20) for a first slot. In some aspects, as part of 812, at 816, the UE determines the blind decoding limit reduction condition does not occur in a second slot. In some aspects, the UE determines a different PDCCH blind decoding limit associated with the second slot. For example, 604 in FIG. 6 illustrates an example where the UE determines a different PDCCH blind decoding limit (35) associated with the second slot.

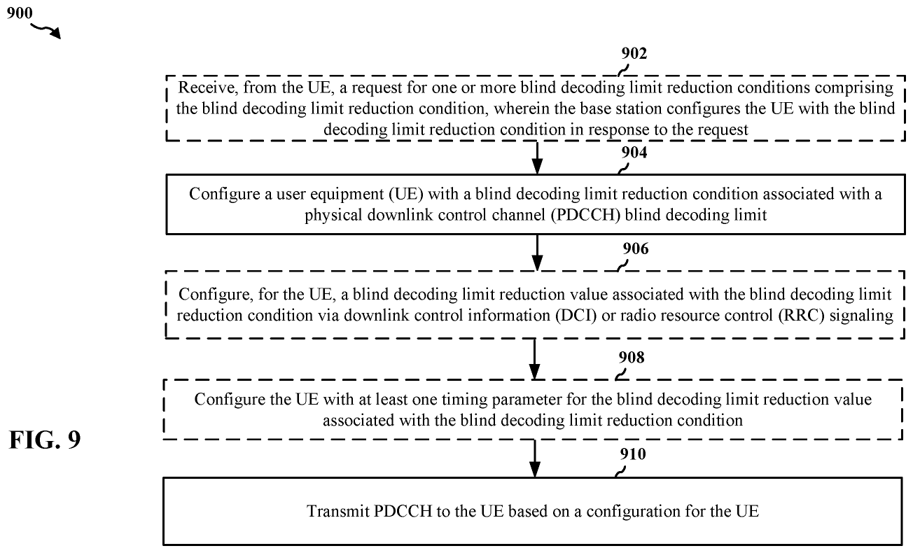

FIG. 9 is a flowchart 900 of a method of wireless communication. The method may be performed by a base station (e.g., the base station 102/180, the base station 504; the apparatus 1102). The method may enable a UE in communication with the base station to perform blind decoding based on a conditional blind decoding limit reduction.

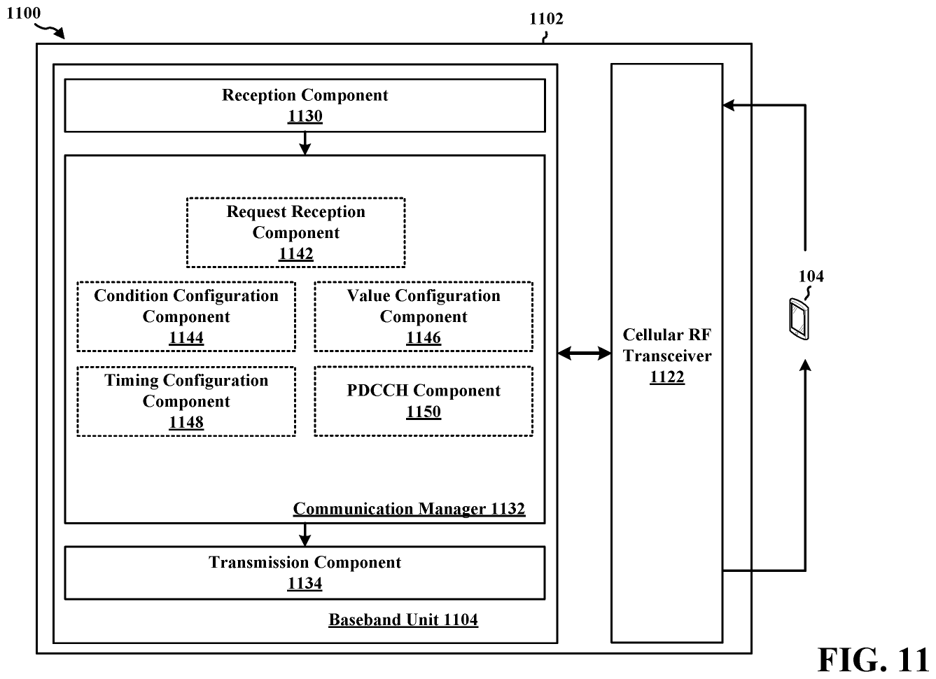

At 902, the base station receives, from a UE, a request requesting one or more blind decoding limit reduction conditions comprising a blind decoding limit reduction condition. 508 in FIG. 5 illustrates an example of a base station 504 receiving a request requesting one or more blind decoding limit reduction conditions from a UE 502. In some aspects, 902 may be performed by request reception component 1142 in FIG. 11. In some aspects, the base station receives the request from the UE in UE assistance information such as UE assistance information via RRC signaling. In some aspects, the request for the blind decoding limit reduction condition is received via a PUSCH, PUCCH, or PRACH. In some aspects, the base station receives the request when the UE establishes a connection with the base station. In some aspects, the request is for a set of blind decoding limit reduction conditions associated with one of: one slot, more than one slots, or one or more conditions. The term “PDCCH blind decoding limit” may refer to a maximum number of monitored PDCCH candidates per slot for a downlink bandwidth part for a single serving cell for a UE. The term “blind decoding limit reduction condition” may refer to a condition, when determined by the UE, triggers a blind decoding limit reduction that reduces the blind decoding limit(s) for one or more slots by a configured value (i.e., the blind decoding limit reduction value).

At 904, the base station configures a UE with a configuration of the blind decoding limit reduction condition. In some aspects, the base station transmits, to the UE, the blind decoding limit reduction condition in response to the request. 510 in FIG. 5 illustrates an example of the base station 504 transmitting a configuration of the blind decoding limit reduction condition to the UE 502. In some aspects, 904 may be performed by condition configuration component 1144 in FIG. 11. In some aspects, the blind decoding limit reduction condition is associated with a slot. For example, 602 in FIG. 6 illustrates an example where the blind decoding limit reduction condition is associated with a slot. In some aspects, the blind decoding limit reduction condition is associated with multiple slots. For example, 604 in FIG. 6 illustrates an example where the blind decoding limit reduction condition is associated with multiple slots. In some aspects, the blind decoding limit reduction condition is based on a type of DCI. For example, the blind decoding limit reduction condition may be based on DCI with a reduced PDCCH overhead, i.e., a multi-TB scheduling DCI that may include information in a plurality of fields that may be decodable to obtain DCI for a plurality of TBs. For example, the decodable information in such a multi-TB scheduling DCI may be jointly decoded according to an encoding scheme where each possible output of the encoding scheme corresponds to a jointly valid combination of at least two fields. In some aspects, the blind decoding limit reduction condition is based on the slot being associated with SPS or a CG. In some aspects, the blind decoding limit reduction condition is based on the slot being configured with UE specific DCI. In some aspects, the blind decoding limit reduction condition is based on a DCI format type (e.g., one or more of DCI x_y or the like, x and y being numbers). In some aspects, the blind decoding limit reduction condition is based on a decoupling of an uplink and downlink non-fallback configuration in a SS set associated with the slot. In some aspects, the base station configures the configuration of one or more blind decoding limit reduction conditions in RRC signaling.

At 906, the base station configures, for the UE, a blind decoding limit reduction value associated with the blind decoding limit reduction condition via DCI or RRC signaling. 512 in FIG. 5 illustrates an example of the base station 504 configuring the UE 502 with the blind decoding limit reduction value. In some aspects, 906 may be performed by value configuration component 1146 in FIG. 11.

At 908, the base station configures the UE with at least one timing parameter for the blind decoding limit reduction value associated with the blind decoding limit reduction condition. 512 in FIG. 5 illustrates an example of the base station 504 configuring the UE 502 with the timing parameter. In some aspects, 808 may be performed by timing configuration component 1148 in FIG. 11. In some aspects, the at least one timing parameter includes a delay between the slot and one or more slots in which the blind decoding is performed based on the PDCCH blind decoding limit. For example, the timing parameter may be k which indicates the delay between slot #1 and slot #3 in examples 602/604/606/608 in FIG. 6. In some aspects, the at least one timing parameter comprises an indicated number of slots. For example, the timing parameter may indicate 2 slots as illustrated in example 602 in FIG. 6. In some aspects, the at least one timing parameter comprises a multi-value indication indicating multiple numbers of slots. For example, the timing parameter may indicate 2, 3, and 4 slots as illustrated in example 604 in FIG. 6. In some aspects, the at least one timing parameter comprises a starting index and a continuous length. For example, the timing parameter may indicate starting index 2 and a continuous length of 2 as illustrated in example 606 in FIG. 6. In some aspects, the at least one timing parameter comprises a minimum value. For example, the timing parameter may indicate a minimum value of 2 as illustrated in example 608 in FIG. 6.

At 910, the base station transmits PDCCH to the UE based on the configuration for the UE. 516 in FIG. 5 illustrates an example of the base station 504 transmitting PDCCH to the UE 502. In some aspects, 910 may be performed by PDCCH component 1150 in FIG. 11.

FIG. 10 is a diagram 1000 illustrating an example of a hardware implementation for an apparatus 1002. The apparatus 1002 is a UE and includes a cellular baseband processor 1004 (also referred to as a modem) coupled to a cellular RF transceiver 1022 and one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, and a power supply 1018. The cellular baseband processor 1004 communicates through the cellular RF transceiver 1022 with the UE 104 and/or BS 102/180. The cellular baseband processor 1004 may include a computer-readable medium/memory. The computer-readable medium/memory may be non-transitory. The cellular baseband processor 1004 is responsible for general processing, including the execution of software stored on the computer-readable medium/memory. The software, when executed by the cellular baseband processor 1004, causes the cellular baseband processor 1004 to perform the various functions described supra. The computer-readable medium/memory may also be used for storing data that is manipulated by the cellular baseband processor 1004 when executing software. The cellular baseband processor 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the cellular baseband processor 1004. The cellular baseband processor 1004 may be a component of the UE 350 and may include the memory 360 and/or at least one of the TX processor 368, the RX processor 356, and the controller/processor 359. In one configuration, the apparatus 1002 may be a modem chip and include just the cellular baseband processor 1004, and in another configuration, the apparatus 1002 may be the entire UE (e.g., see 350 of FIG. 3) and include the aforediscussed additional modules of the apparatus 1002.

The communication manager 1032 includes a request component 1042 that is configured to transmit, to the base station, a request requesting one or more blind decoding limit reduction conditions comprising the blind decoding limit reduction condition, e.g., as described in connection with 802 in FIG. 8. The communication manager 1032 further includes a condition reception component 1044 that is configured to receive, from the base station, a configuration of the blind decoding limit reduction condition, e.g., as described in connection with 804 in FIG. 8. The communication manager 1032 further includes a value reception component 1046 that is configured to receive, from the base station, a first indication of the blind decoding limit reduction value via DCI or RRC signaling, e.g., as described in connection with 806 in FIG. 8. The communication manager 1032 further includes a timing reception component 1048 that is configured to receive, from the base station, a second indication of at least one timing parameter associated with the blind decoding limit reduction value for the blind decoding limit reduction condition, e.g., as described in connection with 808 in FIG. 8. The communication manager 1032 further includes a determining component 1050 that is configured to determine a PDCCH blind decoding limit based on a blind decoding limit reduction condition, e.g., as described in connection with 810 in FIG. 8. The communication manager 1032 further includes a blind decoding component 1052 that is configured to perform blind decoding for a PDCCH using one or more PDCCH candidates of a set of PDCCH candidates based on the determined PDCCH blind decoding limit, e.g., as described in connection with 812 in FIG. 8.

The apparatus may include additional components that perform each of the blocks of the algorithm in the aforementioned flowchart of FIG. 8. As such, each block in the aforementioned flowchart of FIG. 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the cellular baseband processor 1004, includes means for determining a PDCCH blind decoding limit based on a blind decoding limit reduction condition. The cellular baseband processor 1004 may further include means for performing blind decoding for a PDCCH using one or more PDCCH candidates of a set of PDCCH candidates based on the determined PDCCH blind decoding limit. The cellular baseband processor 1004 may further include means for determining an occurrence of the blind decoding limit reduction condition in a first slot, wherein the UE determines the PDCCH blind decoding limit based on the occurrence of the blind decoding limit reduction condition. The cellular baseband processor 1004 may further include means for determining the blind decoding limit reduction condition does not occur in a second slot, wherein the UE determines a different PDCCH blind decoding limit associated with the second slot. The cellular baseband processor 1004 may further include means for receiving, from the base station, a configuration of the blind decoding limit reduction condition. The cellular baseband processor 1004 may further include means for receiving, from the base station, a first indication of the blind decoding limit reduction value via DCI or RRC signaling. The cellular baseband processor 1004 may further include means for receiving, from the base station, a second indication of at least one timing parameter associated with the blind decoding limit reduction value for the blind decoding limit reduction condition. The cellular baseband processor 1004 may further include means for transmitting, to the base station, a request requesting one or more blind decoding limit reduction conditions comprising the blind decoding limit reduction condition.

The aforementioned means may be one or more of the aforementioned components of the apparatus 1002 configured to perform the functions recited by the aforementioned means. As described supra, the apparatus 1002 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

FIG. 11 is a diagram 1100 illustrating an example of a hardware implementation for an apparatus 1102. The apparatus 1102 is a BS and includes a baseband unit 1104. The baseband unit 1104 may communicate through a cellular RF transceiver 1122 with the UE 104. The baseband unit 1104 may include a computer-readable medium/memory. The baseband unit 1104 is responsible for general processing, including the execution of software stored on the computer-readable medium/memory. The software, when executed by the baseband unit 1104, causes the baseband unit 1104 to perform the various functions described supra. The computer-readable medium/memory may also be used for storing data that is manipulated by the baseband unit 1104 when executing software. The baseband unit 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the baseband unit 1104. The baseband unit 1104 may be a component of the BS 310 and may include the memory 376 and/or at least one of the TX processor 316, the RX processor 370, and the controller/processor 375.

The communication manager 1132 includes a request reception component 1142 that that is configured to receive from the UE, a request for one or more blind decoding limit reduction conditions comprising the blind decoding limit reduction condition, wherein the base station configures the UE with the blind decoding limit reduction condition in response to the request, e.g., as described in connection with 902 in FIG. 9. The communication manager 1132 further includes a condition configuration component 1144 that configures a UE with a blind decoding limit reduction condition associated with a PDCCH blind decoding limit, e.g., as described in connection with 904 in FIG. 9. The communication manager 1132 further includes a value configuration component 1146 that configures, for the UE, a blind decoding limit reduction value associated with the blind decoding limit reduction condition via DCI or RRC signaling, e.g., as described in connection with 906 in FIG. 9. The communication manager 1132 further includes a timing configuration component 1148 that configures the UE with at least one timing parameter for the blind decoding limit reduction value associated with the blind decoding limit reduction condition, e.g., as described in connection with 908 in FIG. 9. The communication manager 1132 further includes a PDCCH component 1150 that transmits PDCCH to the UE based on a configuration for the UE, e.g., as described in connection with 910 in FIG. 9.

The apparatus may include additional components that perform each of the blocks of the algorithm in the aforementioned flowchart of FIG. 9. As such, each block in the aforementioned flowchart of FIG. 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the baseband unit 1104, includes means for configuring a UE with a blind decoding limit reduction condition associated with a PDCCH blind decoding limit. The baseband unit 1104 may further include means for transmitting PDCCH to the UE based on a configuration for the UE. The baseband unit 1104 may further include means for configuring, for the UE, a blind decoding limit reduction value associated with the blind decoding limit reduction condition via DCI or RRC signaling. The baseband unit 1104 may further include means for configuring the UE with at least one timing parameter for the blind decoding limit reduction value associated with the blind decoding limit reduction condition. The baseband unit 1104 may further include means for receiving, from the UE, a request for one or more blind decoding limit reduction conditions comprising the blind decoding limit reduction condition, wherein the base station configures the UE with the blind decoding limit reduction condition in response to the request.

The aforementioned means may be one or more of the aforementioned components of the apparatus 1102 configured to perform the functions recited by the aforementioned means. As described supra, the apparatus 1102 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication at a UE, comprising: determining a PDCCH blind decoding limit based on a blind decoding limit reduction condition; and performing blind decoding for a PDCCH using one or more PDCCH candidates of a set of PDCCH candidates based on the determined PDCCH blind decoding limit.

Aspect 2 is the method of aspect 1, further comprising: determining an occurrence of the blind decoding limit reduction condition in a first slot, wherein the UE determines the PDCCH blind decoding limit based on the occurrence of the blind decoding limit reduction condition.

Aspect 3 is the method of any of aspects 1-2, further comprising: determining the blind decoding limit reduction condition does not occur in a second slot, wherein the UE determines a different PDCCH blind decoding limit associated with the second slot.

Aspect 4 is the method of any of aspects 1-3, wherein the blind decoding limit reduction condition is associated with a slot.

Aspect 5 is the method of any of aspects 1-4, wherein the blind decoding limit reduction condition is based on a type of DCI.

Aspect 6 is the method of any of aspects 1-5, wherein the blind decoding limit reduction condition occurs if the slot includes DCI with a reduced PDCCH overhead.

Aspect 7 is the method of any of aspects 1-6, wherein the DCI with a reduced PDCCH overhead in the slot is a TB scheduling DCI.

Aspect 8 is the method of any of aspects 1-7, wherein the blind decoding limit reduction condition is based on the slot being associated with SPS or a CG.

Aspect 9 is the method of any of aspects 1-8, wherein the blind decoding limit reduction condition is based on the slot being configured with UE specific DCI.

Aspect 10 is the method of any of aspects 1-8, wherein the blind decoding limit reduction condition is based on a DCI format type.

Aspect 11 is the method of any of aspects 1-10, wherein the blind decoding limit reduction condition is based on a decoupling of an uplink and downlink non-fallback configuration in a SS set associated with the slot.

Aspect 12 is the method of any of aspects 1-11, further comprising: receiving, from the base station, a configuration of the blind decoding limit reduction condition.

Aspect 13 is the method of any of aspects 1-12, wherein the UE receives the configuration of one or more blind decoding limit reduction conditions in RRC signaling.

Aspect 14 is the method of any of aspects 1-13, wherein the UE determines the PDCCH blind decoding limit to be a blind decoding limit reduction value based on an occurrence of the blind decoding limit reduction condition.

Aspect 15 is the method of any of aspects 1-14, further comprising: receiving, from the base station, a first indication of the blind decoding limit reduction value via DCI or RRC signaling.

Aspect 16 is the method of any of aspects 1-15, further comprising: receiving, from the base station, a second indication of at least one timing parameter associated with the blind decoding limit reduction value for the blind decoding limit reduction condition.

Aspect 17 is the method of any of aspects 1-16, wherein the at least one timing parameter includes a delay between the slot and one or more slots in which the blind decoding is performed based on the PDCCH blind decoding limit.

Aspect 18 is the method of any of aspects 1-17, wherein the at least one timing parameter comprises an indicated number of slots.

Aspect 19 is the method of any of aspects 1-18, wherein the at least one timing parameter comprises a multi-value indication indicating multiple numbers of slots.

Aspect 20 is the method of any of aspects 1-19, wherein the at least one timing parameter comprises a starting index and a continuous length.

Aspect 21 is the method of any of aspects 1-20, wherein the at least one timing parameter comprises a minimum value.

Aspect 22 is the method of any of aspects 1-21, wherein the blind decoding limit reduction value is applicable to one slot in the one or more slots in which the blind decoding is performed based on the PDCCH blind decoding limit.

Aspect 23 is the method of any of aspects 1-22, wherein the blind decoding limit reduction value is applicable to multiple slots in the one or more slots in which the blind decoding is performed based on the PDCCH blind decoding limit.

Aspect 24 is the method of any of aspects 1-23, further comprising: transmitting, to the base station, a request requesting one or more blind decoding limit reduction conditions comprising the blind decoding limit reduction condition.

Aspect 25 is the method of any of aspects 1-24, wherein the UE transmits the request to the base station in UE assistance information.

Aspect 26 is the method of any of aspects 1-25, wherein the request for the blind decoding limit reduction condition is transmitted via a PUSCH or a PUCCH.

Aspect 27 is the method of any of aspects 1-25, wherein the request for the blind decoding limit reduction condition is transmitted via a PRACH.

Aspect 28 is the method of any of aspects 1-27, wherein the UE transmits the request when the UE establishes a connection with the base station.

Aspect 29 is the method of any of aspects 1-28, wherein the UE receives, from the base station, the blind decoding limit reduction condition in response to the request.

Aspect 30 is the method of any of aspects 1-29, wherein the request is for a set of blind decoding limit reduction conditions associated with one of: one slot, more than one slots, or one or more conditions.

Aspect 31 is a method of wireless communication at a base station, comprising: configuring a UE with a blind decoding limit reduction condition associated with a PDCCH blind decoding limit; and transmitting PDCCH to the UE based on a configuration for the UE.

Aspect 32 is the method of aspect 31, wherein the base station configures the UE to apply a first PDCCH blind decoding limit in one or more slots if the blind decoding limit reduction condition occurs and to apply a second PDCCH blind decoding limit in the one or more slots if the blind decoding limit reduction condition does not occur.

Aspect 33 is the method of any of aspects 31-32, wherein the blind decoding limit reduction condition is associated with a slot.

Aspect 34 is the method of any of aspects 31-33, wherein the blind decoding limit reduction condition is based on a type of DCI.

Aspect 35 is the method of any of aspects 31-34, wherein the blind decoding limit reduction condition occurs if the slot includes DCI with a reduced PDCCH overhead.

Aspect 36 is the method of any of aspects 31-35, wherein the DCI with the reduced PDCCH overhead in the slot is a TB scheduling DCI.

Aspect 37 is the method of any of aspects 31-36, wherein the blind decoding limit reduction condition is based on the slot being associated with SPS or a CG.

Aspect 38 is the method of any of aspects 31-37, wherein the blind decoding limit reduction condition is based on the slot is being configured with UE specific DCI.

Aspect 39 is the method of any of aspects 31-38, wherein the blind decoding limit reduction condition is based on a DCI format type.

Aspect 40 is the method of any of aspects 31-39, wherein the blind decoding limit reduction condition is based on a decoupling of an uplink and downlink non-fallback configuration in a SS set associated with the slot.

Aspect 41 is the method of any of aspects 31-40, wherein the base station configures the UE with one or more blind decoding limit reduction conditions in RRC signaling.

Aspect 42 is the method of any of aspects 31-41, further comprising: configuring, for the UE, a blind decoding limit reduction value associated with the blind decoding limit reduction condition via DCI or RRC signaling.

Aspect 43 is the method of any of aspects 31-42, further comprising: configuring the UE with at least one timing parameter for the blind decoding limit reduction value associated with the blind decoding limit reduction condition.

Aspect 44 is the method of any of aspects 31-43, wherein the at least one timing parameter includes a delay between the slot and one or more slots in which the blind decoding is to be performed based on the PDCCH blind decoding limit.

Aspect 45 is the method of any of aspects 31-44, wherein the at least one timing parameter comprises an indicated number of slots.

Aspect 46 is the method of any of aspects 31-45, wherein the at least one timing parameter comprises a multi-value indication indicating multiple numbers of slots.

Aspect 47 is the method any of aspects 31-46, wherein the at least one timing parameter comprises a starting index and a continuous length.

Aspect 48 is the method of any of aspects 31-47, wherein the at least one timing parameter comprises a minimum value.

Aspect 49 is the method of any of aspects 31-48, wherein the blind decoding limit reduction value is applicable to one slot in the one or more slots in which the blind decoding is performed based on the PDCCH blind decoding limit.

Aspect 50 is the method of any of aspects 31-49, wherein the blind decoding limit reduction value is applicable to multiple slots in the one or more slots in which the blind decoding is performed based on the PDCCH blind decoding limit.

Aspect 51 is the method of any of aspects 31-50, further comprising: receiving, from the UE, a request for one or more blind decoding limit reduction conditions comprising the blind decoding limit reduction condition, wherein the base station configures the UE with the blind decoding limit reduction condition in response to the request.

Aspect 52 is the method of any of aspects 31-51, wherein the request for the blind decoding limit reduction condition is transmitted via a PUSCH.

Aspect 53 is the method of any of aspects 31-51, wherein the request for the blind decoding limit reduction condition is transmitted via a PUCCH.

Aspect 54 is the method of any of aspects 31-51, wherein the request is for the blind decoding limit reduction condition based on a PRACH.

Aspect 55 is the method of any of aspects 31-54, wherein the base station receives the request when the base station establishes a connection with the UE.

Aspect 56 is the method of any of aspects 31-55, wherein the request is for a set of blind decoding limit reduction conditions associated with one slot.

Aspect 57 is the method of any of aspects 31-55, wherein the request is for one or more blind decoding limit reduction conditions associated with more than one slots.

Aspect 58 is the method of any of aspects 31-57, wherein the request is for one or more blind decoding limit reduction conditions associated with one or more conditions.

Aspect 59 is an apparatus for wireless communication including at least one processor coupled to a memory and configured to implement a method as in any of aspects 1 to 30.

Aspect 60 is an apparatus for wireless communication including at least one processor coupled to a memory and configured to implement a method as in any of aspects 31 to 58.

Aspect 61 is an apparatus for wireless communication including means for implementing a method as in any of aspects 1 to 30.

Aspect 62 is an apparatus for wireless communication including means for implementing a method as in any of aspects 31 to 58.

Aspect 63 is a computer-readable medium storing computer executable code, where the code when executed by a processor causes the processor to implement a method as in any of aspects 1 to 30.

Aspect 64 is a computer-readable medium storing computer executable code, where the code when executed by a processor causes the processor to implement a method as in any of aspects 31 to 58.

What is claimed is:

1. A method of wireless communication at a user equipment (UE), comprising:
determining a physical downlink control channel (PDCCH) blind decoding limit based on a blind decoding limit reduction condition; and
performing blind decoding for a PDCCH using one or more PDCCH candidates of a set of PDCCH candidates based on the determined PDCCH blind decoding limit.

2. The method of claim 1, further comprising:
determining an occurrence of the blind decoding limit reduction condition in a first slot, wherein the UE determines the PDCCH blind decoding limit based on the occurrence of the blind decoding limit reduction condition.

3. The method of claim 2, further comprising:
determining the blind decoding limit reduction condition does not occur in a second slot, wherein the UE determines a different PDCCH blind decoding limit associated with the second slot.

4. The method of claim 1, wherein the blind decoding limit reduction condition is associated with a slot.

5. The method of claim 4, wherein the blind decoding limit reduction condition is based on a type of downlink control information (DCI).

6. The method of claim 5, wherein the blind decoding limit reduction condition occurs if the slot includes downlink control information (DCI) with a reduced PDCCH overhead.

7. The method of claim 5, wherein the DCI with a reduced PDCCH overhead in the slot is a multi-transport block (TB) scheduling DCI.

8. The method of claim 4, wherein the blind decoding limit reduction condition is based on the slot being associated with semi-persistent scheduling (SPS) or a configured grant (CG).

9. The method of claim 4, wherein the blind decoding limit reduction condition is based on the slot being configured with UE specific DCI.

10. The method of claim 4, wherein the blind decoding limit reduction condition is based on a DCI format type.

11. The method of claim 4, wherein the blind decoding limit reduction condition is based on a decoupling of an uplink and downlink non-fallback configuration in a search space (SS) set associated with the slot.

12. The method of claim 4, further comprising:
receiving, from 1 base station, a configuration of the blind decoding limit reduction condition.

13. The method of claim 12, wherein the UE receives the configuration of one or more blind decoding limit reduction conditions in radio resource control (RRC) signaling.

14. The method of claim 12, wherein the UE determines the PDCCH blind decoding limit to be a blind decoding limit reduction value based on an occurrence of the blind decoding limit reduction condition.

15. The method of claim 14, further comprising:
receiving, from the base station, a first indication of the blind decoding limit reduction value via downlink control information (DCI) or radio resource control (RRC) signaling.

16. The method of claim 14, further comprising:
receiving, from the base station, a second indication of at least one timing parameter associated with the blind decoding limit reduction value for the blind decoding limit reduction condition.

17. The method of claim 16, wherein the at least one timing parameter includes a delay between the slot and one or more slots in which the blind decoding is performed based on the PDCCH blind decoding limit.

18. The method of claim 16, wherein the at least one timing parameter comprises an indicated number of slots.

19. The method of claim 16, wherein the at least one timing parameter comprises a multi-value indication indicating multiple numbers of slots.

20. The method of claim 16, wherein the at least one timing parameter comprises a starting index and a continuous length.

21. The method of claim 16, wherein the at least one timing parameter comprises a minimum value.

22. The method of claim 17, wherein the blind decoding limit reduction value is applicable to one slot in the one or more slots in which the blind decoding is performed based on the PDCCH blind decoding limit.

23. The method of claim 17, wherein the blind decoding limit reduction value is applicable to multiple slots in the one or more slots in which the blind decoding is performed based on the PDCCH blind decoding limit.

24. The method of claim 12, further comprising:
transmitting, to the base station, a request requesting one or more blind decoding limit reduction conditions comprising the blind decoding limit reduction condition.

25. The method of claim 24, wherein the UE transmits the request to the base station in UE assistance information.

26. The method of claim 24, wherein the request for the blind decoding limit reduction condition is transmitted via a physical uplink shared channel (PUSCH) or a physical uplink control channel (PUCCH).

27. The method of claim 24, wherein the request for the blind decoding limit reduction condition is transmitted via a physical random access channel (PRACH).

28. The method of claim 24, wherein the UE transmits the request when the UE establishes a connection with the base station.

29. The method of claim 28, wherein the UE receives, from the base station, the blind decoding limit reduction condition in response to the request.

30. The method of claim 24, wherein the request is for a set of blind decoding limit reduction conditions associated with one of: one slot, more than one slots, or one or more conditions.
